(19) United States
(12) Patent Application Publication
(10) Pub. No.: US 2008/0225052 A1
(43) Pub. Date: Sep. 18, 2008

(54) Digital reading device and method

(76) Inventor: Jonathan Elliott Martin Alston-Hughes, Los Angeles, CA (US)

Correspondence Address: Colin P. Abrahams, Suite 400, 5850 Canoga Avenue, Woodland Hills, CA, 91367, US

(21) Appl. No.: 11/895,171

(22) Filed: Aug. 23, 2007

Related U.S. Application Data
(60) Provisional application No. 60/850,765, filed on Oct. 11, 2006.

(51) Int. Cl. G06T 1/00

(52) U.S. Cl. 345/522

(57) ABSTRACT

A digital reading device comprises a pair of tablet portions each having a display screen, with the tablets being foldable relative to each other between a closed position wherein the display screens are protected and not visible and an open position wherein the screens are adjacent and coplanar with respect to each other so as the present a book-like viewing area. A receiver is provided for receiving text and graphics separable into units or pages from a remote source and displaying the text and graphics on the display screens. The text and graphics received from the remote source may be stored in memory. A set of simple navigation keys is provided for storing the text and graphics in the memory and reading the text and graphics.

### CROSS REFERENCE TO RELATED APPLICATIONS

This application claims the benefit of U.S. Provisional Patent Application No. 60/850,765 filed Oct. 11, 2006, which is incorporated herein by reference in its entirety.

### FIELD OF THE INVENTION

This invention relates to a digital reading device, also referred to as a digital board herein, and methods for delivering newspapers, magazines, books and other text and visual material electronically to a digital press device which is specially configured to receive such material. Preferably, the material is delivered to the digital press device by means of wireless data transmission and the digital press device has hardware which is configured to receive such material wirelessly.

In this specification, the terms digital press device is intended to be broadly interpreted and includes not only press and newspaper material and releases but also other types of material such as books, magazines, periodicals, photographs, video to name examples only.

### SUMMARY OF THE INVENTION

According to one aspect of the invention, there is provided a digital reading device comprising a pair of tablet portions each having a display screen, the tablets being foldable relative to each other between a closed position wherein the display screens are protected and not visible and an open position wherein the screens are adjacent and coplanar with respect to each other so as the present a book-like viewing area; receiving means for receiving text and graphics separable into units or pages from a remote source and displaying the text and graphics on the display screens; memory for storing the text and graphics received from the remote source; and a set of simple navigation keys for storing the text and graphics in the memory and reading the text and graphics.

The digital press device and method in accordance with the invention is a new type of service that may provide data comprising one or more daily newspapers or monthly magazine or the like selected by the user via WIFI (IEEE802.11B), satellite or broadband to a digital press device that receives the data sent (the newspaper or magazine). One beneficial consequence of using such a service of receiving the daily press or magazines is to eliminate or substantially reduce the constant and costly use of paper and ink. This in turn may help the journalism and reader industry become more cost effective and more reliable, the latter since any mistakes or inconsistences can be corrected the same day.

The digital press device and method may also be extended to incorporate the transmission of other material, such as for example only books, which readers will be able to download to the digital press device of the invention and also to DVDs, computers or other electronic media so as to constitute an electronic or paperless library, instead of buying a book or other written material. The digital press device and method of the invention is more environmentally correct and safe, for many trees will be saved and the pollutants resulting from printed material production and delivery can be significantly reduced. It is well known that the planet earth is currently undergoing somewhat dramatic climate changes and that we are now living in uncertain times as a result of global warming. As such, any process or changes which help to preserve our trees and the environment by sustaining forests and facilitating recycling can only be advantageous.

The digital press device and method of the invention provides a simple electronic device and method, much less complex and user friendly than a conventional computer, whereby data, newspapers, books and the like can be received for the many people who are not or will not become computer savvy. It is also a device which complements a computer, is easily portable, and provides a simple, cost effective and environmentally friendly interface for people to read the daily press and periodicals. Because of the limited amount of trees and the huge demand for building material, not to mention how important it is to scale back the loss of trees for the planet's ecology, the digital press device and method of the invention will allow many of the world's population continued ability to have relatively easy access to and to read the daily presses, magazines, periodicals, books and the like. A choice will thus be available to readers to either obtain a vanity printing for the elite at a high cost for a book or the alternative of securing material electronically in accordance with the invention which may be available in a widespread manner for a much reduced cost.

It is entirely likely that a crisis may be faced in the near future over the printing of books, magazines, newspapers and the like on paper. An advantage of the invention is that the potential certainly exists for publishers to greatly reduce the vast quantities of printed material which is churned out today, and that, moreover, significant savings and convenient access will be enjoyed by the subscriber. Everyone will be pleased with and benefit from the positive environmental impact.

Regardless of environmental and climactic changes taking place on the planet now and in the future, there will in all likelihood be a continued need for printed matter of all types. Printed matter is one of our important forms of mass communication. Schools, universities and all kinds of institutions will continue to have a need for a form of printed matter. In one aspect of the invention, students may call certain telephone numbers designated for specific public or private schools and would be able to download their school books on the digital press device. It will no longer be necessary to carry books around, since the content would be stored on a digital press device. As is the case when buying many types of appliances, the owner or user of a digital board would be able to call the designated (toll free) telephone numbers, providing a receipt and/or digital board number or other identifying information and receive the instructions for further use or operation. One may save or delete the instructions when done with them. The use of a digital board will enable the student or other user to access and keep the necessary information for continued communication and education, all without the use of ink and paper. The digital board is not a computer, but merely a simple data receiving and display device to receive printed material in an electronic format for reading, downloading, saving or deleting as desired by the user.

Different versions of the digital press device may be provided in accordance with the invention. For example, one form of the device may be provided for commercial use, such as for newspapers, periodicals, printed matter in commercial contexts. In this regard, the digital board may even receive product instructions for items purchased at stores.

Another type or model of the digital board may be provided for students, medical doctors, and professionals who need books for studying or research. The digital press device may comprise a mini electronic library for private or professional books, people who love novels or simply reading. The digital boards can be used by the public library to send books to readers for a fee. Various libraries have certain specialized book collections and these can place their collections of books into electronic form. In one embodiment, readers can go to the library, obtain a library digital board that will carry the books selected to read and then return the digital board to the library within the time allowed. In other words, digital boards with customized and variable content can be made available for rental, borrowing or purchase by a library. The public library can then clear the digital board of its contents once it is returned by the reader and set the digital board to receive a new group of books or other material for the next reader or borrower. Further, libraries may offer their collection of books and periodicals for a small fee for download to either purchase or rent for limited periods of time.

One benefit of the digital press device is that when the user is reading the paper on the two screens that lock together as on a long screen (the photos on the different pages), there will preferably be a button on the bottom portion of one of the screens to activate the photos displayed, giving the newspaper or magazine the option of a 2 or 3 minute video of an actual event that the photo is depicting. Alternatively, only a still shot may be provided. The digital boards receive data though WIFI or satellite even broadband.

It may be an option to purchase the digital device with different settings configured for different providers such as phone companies, satellite companies, and those who provide service accounts.

One aspect of the invention requires that the device connect wirelessly to a source provider by means other than the Internet. A dedicated line or non-public connection may preferably be established. As such, the transmissions to the device are not carried out on-line over the Internet. It is more in the nature of a dedicated telephone line. This makes operation and use of the device much simpler and ensures that there will be no or substantially reduced spam, or junk mail, or other potentially harmful receipts by the device which could impair its function.

### BRIEF DESCRIPTION OF THE DRAWINGS

In the drawings:

FIG. 1 is a schematic view of a digital board device in accordance with one aspect of the invention;

FIG. 2 is a schematic view of a digital board device in accordance with another aspect of the present invention;

FIG. 3 is a schematic view of a digital board device in accordance with yet another aspect of the present invention;

FIG. 4 is a perspective schematic view of a digital display device similar to that shown in FIG. 3 of the drawings;

FIG. 5 shows a digital board device in one embodiment of the invention with information and display options on the screen or monitor; and

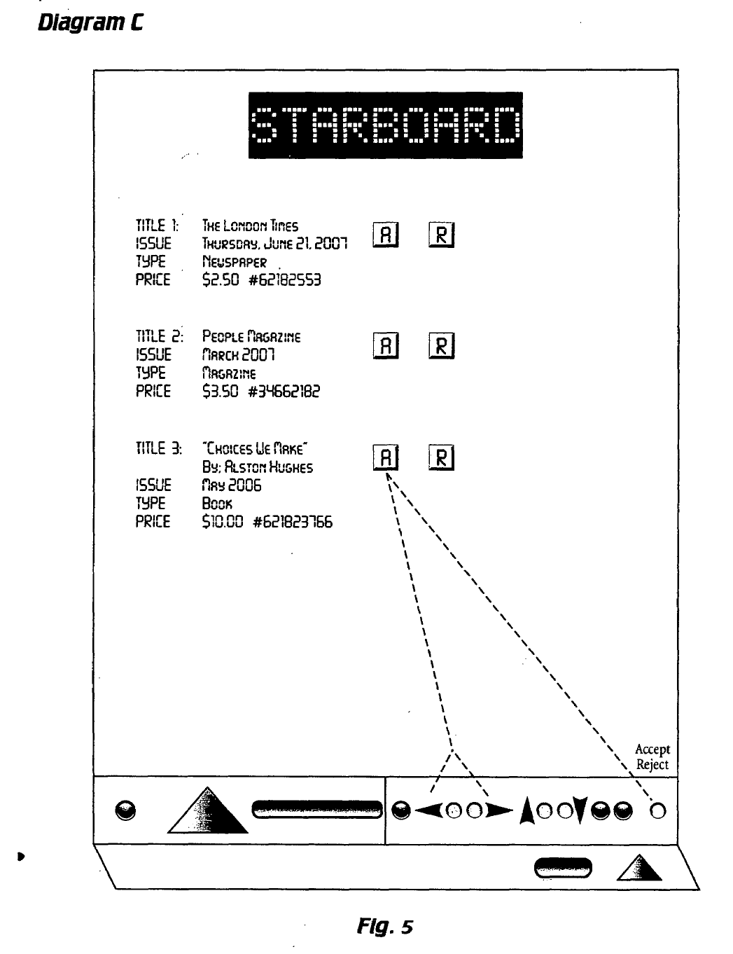

FIG. 6 is a is a schematic view of a digital board device in accordance with yet another aspect of the present invention.

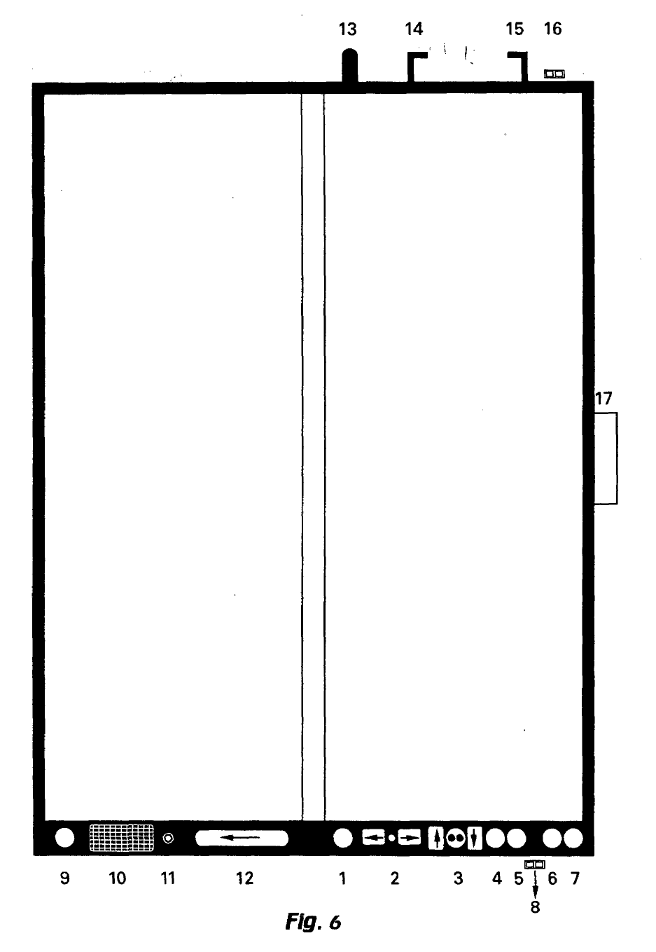

### DESCRIPTION OF VARIOUS METHODS OF INVENTION

In accordance with one aspect of the invention, newspaper or magazine publishers can send or transmit digital versions of their newspapers and/or magazines to a selected service provider (for example, by WIFI, IEEE802.11B, satellite or broadband), and thereby provide the newspaper etc. to their readers or subscribers. Any mistakes or inaccuracies in the content transmitted can be corrected within hours, and revised corrected versions of the content placed on the subscriber's digital press device.

In accordance with another aspect of the invention, to be described in more detail below, the digital press device may comprise a unique double screen digital board which may be purchased by the reader or subscriber which will allow the press or publishers to place on the double screen text, still photos, or photos that with the touch of a button will activate the still photo into a mini video up to 5 minutes. While a double screen as will be described is a preferred embodiment, other formats of screens or monitors are certainly within the scope of the invention.

Mini videos may be provided for newspapers, magazines and periodicals and of course books and other material.

It will be appreciated that the digital device of the invention will be more efficient and convenient for today's reader. For example, people who work on oil rigs, coal miners, people living in the countryside or rural areas will be able to access and receive newspapers and other material electronically with a simple to operate device. Additionally, those who may be on holiday or a on business trip will be able to receive their daily newspapers or magazines on the digital press device wherever they may be.

Many options and choices would be available. Some examples only would include the international availability of the material. The digital press device of the invention will allow a reader to receive daily issues or just weekend issues. One reader may receive his daily press in English and another may want the same issue, but in Spanish, or whatever other language is made available by the publishers. One reader can receive his local times on Sunday along with the London Times, New York Times or Hong Kong Times, as selected and customized. The result is that both the local and international press will be available to the reader, according to preference. A reader will not have to miss his daily or weekly paper or magazine because he is not at home or at the regular physical delivery address.

### Description of Embodiments of the Digital Device

In accordance with one embodiment of the invention, there is provided a digital press device comprising a pair of digital boards which are two, preferably eight by ten inch screens releasably attached together along one long edge thereof, allowing the two screens to open and close in a book-like fashion. When the two screens are opened up and side by side, they may lock into place, forming a 10 by 16 inch screen. Note that the invention is not intended to be limited to screens of these dimensions and any size screen or screens may be used. The screens may be of different sizes to each other. These two screens may be respectively designated for convenience as screen “A” which is the left side screen and screen “B” which is the right side screen.

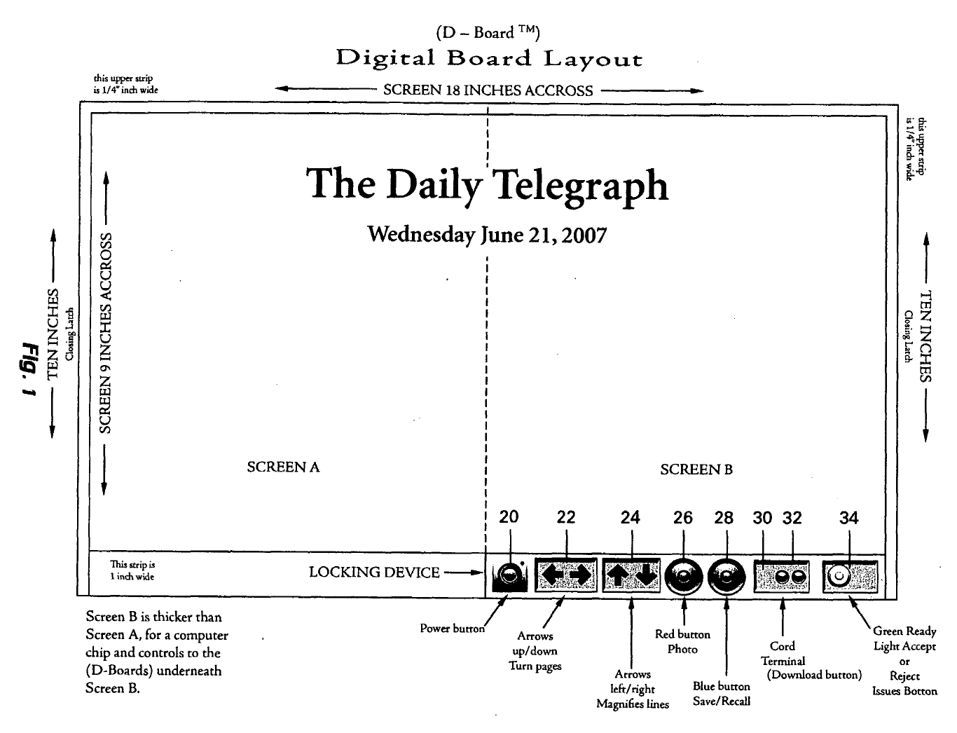

FIG. 1 shows a digital press device in accordance with one aspect of the invention.

Preferably, in one aspect of the invention, under the bottom of screen B on the frame surrounding the screen B, there are seven buttons from left to right, as clearly seen in FIG. 1 of the drawings. These buttons operate the two screens A and B as one long screen or as a continuous screen, or divide it as two pages in a book or magazine. The user may select the type of format desired, or the publisher may transmit the content or material in one format for display on the screens A and B. The device will set itself in many instances according to the reading material selected by the user.

A brief description of the buttons and their operation with reference to FIG. 1 of the drawings is provided below. Note that this is one embodiment only and many variations and combinations are possible within the scope of the invention, which is not limited to any specific embodiment herein described.

The first button, having reference number 20, turns the digital press device or digital board on or off.

The second button, having reference number 22, is preferably a rectangular button with two arrows thereon each pointing in the opposite direction, either to the left or to the right. This button 22 has the effect of turning the pages on the paper, book or magazine forwards or backwards, as selected.

The third button, having reference number 24, has two arrows thereon, one pointing upward, and the other pointing downward. This button 24 magnifies a sentence or other appropriate section of the material at any one time, from top to bottom. In this way, the reader can conveniently scroll up and down the article or page which is being read. The magnified sentence or section may also lit more brightly, which allows the reader to skim though articles with ease. This effect also makes it easier on the human eye to read digital data on the screens or monitors.

The fourth button, having reference number 26, is preferably red in color for easy identification and has the word “PHOTO” printed on it or adjacent it. Use of this button 26 allows the reader to activate one or more of the photos that are displayed on the screen A or B, and this may preferably result in 1 to 5 minute (or any other suitable length) short videos of newsworthy or related material such as speeches, comments or live footage of an actual event related to the article of which it is a part. There may also be a hidden mini grill on the top edge portion of the frame of the digital press device over screen B (the right screen) which conceals a speaker and from which sound associated with the photo, video or other material may emanate. The speaker may be located at bottom left of Screen A and may be lit when in use.

The fifth button, having reference number 28, is preferably blue in color and allows the reader to save the current issue of the paper, magazine or a book, and retrieve it later for reading at a convenient time, or to simply download the material into a computer, DVD recorder or printer of the user and to keep it as part of an electronic or paper library. This button 28 may also clear the storage space on the digital press device, in order to make room for and receive more data (such as papers).

In one form, the digital press device may be able to receive and store up to five daily issues. For example, the reader may receive Monday through Friday editions of a newspaper and then clear the digital press device by erasing material thereon or by downloading material using a cord or cable attachment that may be connected to the digital press device under the button number six (to be described below) which is for downloading any material on the digital press device. In this manner, the digital board can be cleared or partially cleared on, say, Friday night in order to be ready in terms of storage space available to receive Saturday and Sunday's paper along with five other newspapers from around the world. Thus, a reader can receive the local times and the London, New York or Hong Kong Times on Sunday morning and download them into a computer or recorder in order to clear the digital press device and receive five more issues from around the world the same day.

The device may have a very substantial storage capacity so that material can be stored without having to download material to a hard copy. Further, copyrighted material may have copying restrictions.

The sixth button, having reference number 30, comprises a terminal 32 underneath it or adjacent it for a connector cable that attaches to the digital board and another device such as a computer or printer. When this button 30 is pushed, instructions may be displayed on screen B (right screen) providing prompts to assist in the download or printing out of stored data. This procedure also clears the digital board or press device storage space in order to make way for and receive new data. A reader can also simply erase, permanently, any and/or all stored data.

The seventh button, having reference number 34, is that which is used to activate all new issues (such as daily newspapers, monthly periodicals, magazines and the like). Readers will be able to access and download new issues at a time selected by the publisher or other provider, such as at midnight. All new issues may be ready to view between, for example, 12:00 AM (midnight) and 3:00 AM on the digital board or digital press device. When this button 34 is pushed, the digital board sends out a specific signal to a satellite, WIFI or broadband for retrieving the ordered data (paper or periodical) that has been sent by the publishers.

Like a cell phone call, the digital press device may place a call to the link receiving the requested issue. When the digital board is purchased, the user or reader or subscriber will be able to set up an account using a credit card (or other suitable financial arrangements) to purchase all the periodicals that may be selected, with the ability to add to the list of subscriptions at any time with a call to a predetermined telephone number where live operators or automated operators will take orders. The telephone numbers may also be used to add funds to a pre-paid account associated with the digital board with money cards purchased at retail stores. Once an order is taken, the funds will be deducted from this designated account. There may, furthermore, be built-in safety features included in this order system to prevent or deter identity theft or misappropriation of financial information. Users having accounts for digital press devices will be able to place an order and have the option to reject or decline that order or an individual issue or subscription when it is first retrieved by on the digital board. There may be options to facilitate cancellation of an order or to accept the material upon the arrival of the first issue of a monthly subscription. Once a subscriber accepts an issue on the digital board, the transaction would be completed and funds would be deducted from a user's designated account. Further, once a user accepts the first issue of a subscription, the whole amount of that particular subscription which has been ordered would be deducted from the designated account. This option in the system would provide the digital board owner with the opportunity to cancel any order made by unauthorized parties. In one form, the accidental rejection or refusal by the user of the first issue of a multiple issue subscription would have the effect of cancelling the entire order, and it would be necessary in such a situation to call back and reorder again.

How service and digital press device may work: Readers or subscribers will be able to purchase these digital boards at electronic stores or other outlets that sell digital software etc. Accounts can be set up for the reader by publishers of newspapers, books and the like or by clearing houses set up for this purpose. Alternatively, the reader may be able to purchase a pre-paid board or digital press device that allows a subscriber or reader to place funds and set up digital board accounts as needed to purchase issues or books or other material. A code may be provided with the board, and the code may be used to retrieve the issues ordered. The digital boards may have a computer chip with a special code for that board. Once the data is transmitted to the board, a user will have the option to accept or reject the issue retrieved by the board. This feature protects the board owner from having to accept issues or other material which were not ordered or resulting from mistakes made by the telephone operator. Upon accepting any issue sent, that issue would become locked into the board, in an appropriate memory storage device in the digital press board, and the user may read the content immediately or at a later convenient time when there will be no interruption. Lighting on the digital board, to be described further below, would enable the user to operate the digital board and read the content stored in the memory thereof in dark or poorly lighted places such as in a tunnel, a basement, or in a rural area where power supplies may be unavailable.

In one aspect, a subscriber may call an operator to place an order, and the appropriate board number provided for identification. The operator may be able to send the user selected material immediately, while on the phone, so that it will show on the device and may be rejected or accepted, as discussed herein. When titles or material are accepted, the device may automatically enter a stand by mode, ready to receive the purchased material within a short or longer time period.

If the digital board is stolen, lost or destroyed, a reader can place a call to the service provider and report it stolen or destroyed, identifying the specific digital press device by its specific special code in the board, and all data would then cease to transmit to that board. In such a situation, the service and/or and existing accounts, prepaid or otherwise, would be terminated and switched to a new board by conventional arrangements. The device may have a security code that is entered and required to initiate the device.

The digital boards (preferably comprising two 8×10 screens arranged side by side), when in the open position, thus have at the lower end of the right screen (or elsewhere) a row of touch control buttons preferably arranged from left to right. In one form of the invention, the first button is to turn the device and screen on and off. The second button cluster turns pages on the screen from page one and forward through the document; the second button has arrows pointing to the left and right respectively to indicate forward and back movement through the document. The third button controls the individual lines of the article, such as more brightly illuminating and/or magnifying the first line of the story, making it easier to read; the third button has an arrow pointing up and down so the user may magnify the first line, or second, going up or down the pages. The fourth button is preferably red and may be used to transform any still photo to video form that the newspaper installs. Some photos are still and some may be video. This button will activate any of the photos that are video-capable. The fifth button is preferably blue and its purpose is to save the current issue of the paper, magazine, book or the like. In one embodiment, the boards will store 3 to 7 issues of a newspaper, and 2 issues of a magazine; with this button, the user will also be able to go back to previous issues. The sixth button may have a white circle around it and just below it an opening for a cable that comes with the board; the cable plugs into a unit (digital board) as well as to a computer, DVD burner or to a printer, and is able to transfer data from the digital board to the DVD or computer in order to save all selected and transferred issues for viewing at a desired later date.

The existence of Ipods for music or cell phones that receive texts or even lap top computers is well established. All require certain capabilities. The digital board in accordance with the invention, and its simplicity, is for the purpose of servicing those users who are not especially interested in computer downloading or cell phones, Ipods and other communication devices. These devices may be inconvenient for the people who are not necessarily computer or blackberry savvy, and just want something very simple to turn on and off in order to read a newspaper or magazine.

The digital boards are preferably very thin, and need not be as thick as a laptop for there is no need for a keyboard, very light weight, and have a coded number thereon for easy operation. To receive its daily press or magazine, the same code number can be used to turn the board off, so if the digital board is lost or stolen or destroyed, then all data will cease to be transmitted to that board and a new board can be issued to the subscriber. There is a computer chip that receives data and transmits it to a memory storage device and then to the screen and commands the data to act according to controls as operated by the user. The level of service may vary, as with a cell phone that receives local or international calls, depending on the type of subscription one has, or the credit line on the digital board. Preferably, the digital press devices of the invention are light weight, grey in color, and made of durable hard plastic on the outside. Subscription providers or independent companies can sell customized versions for those who desire any individual features, or those who simply like something special. Hidden codes can be placed on the boards, so if stolen they can be identified.

### Description of Another Embodiment of the Digital Device

As mentioned above, there may be two styles of digital boards. One may be the standard device for commercial use. The public can purchase this style for viewing newspapers, periodicals and various commercial printed matters. The second style of board that may be made available is a more heavy duty digital board which may have a higher capacity for storing thousands of documents, making it perfect for use with books, manuals and atlases. Such a style would in fact comprise a mini digital or electronic library for students in college, high school, or elementary schools, and even medical or trade technical students which may be customized for the particular user. A user can utilize the digital boards to carry all required books. It may be further used in conjunction with public library services to carry or travel with a selection of books for the desired particular need.

A further embodiment of the digital board and its components are now described.

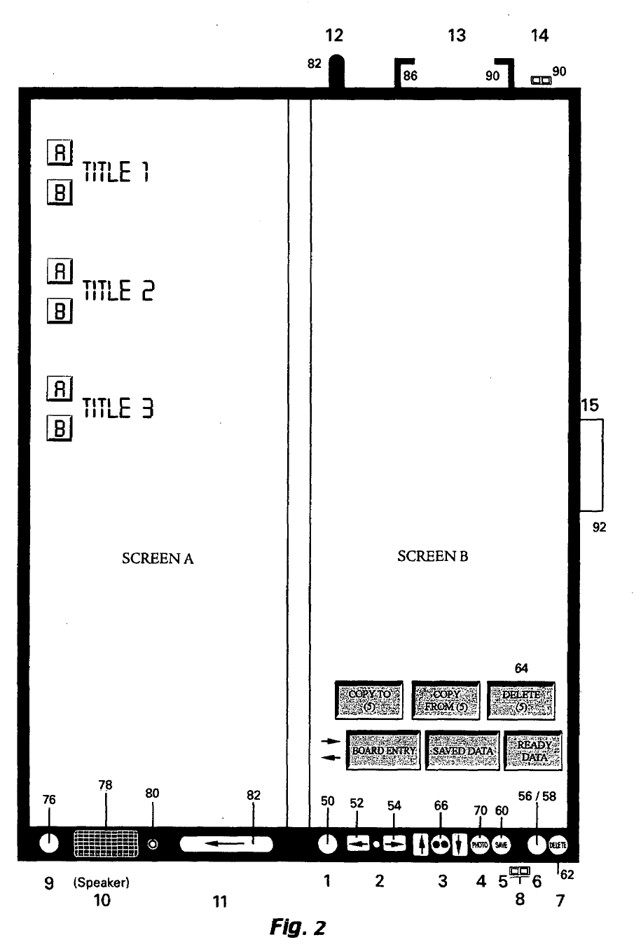

With reference to FIG. 2 and other figures of the drawings, there is shown embodiments of the invention, which includes a button 50 for turning the power on or off. This button 50 will only work when the digital board is in the open position and the two screens A and B on the inside are pushed together at their center as shown in FIG. 2 and engage with a clicking sound that indicates the two screens are properly locked together. At this point, the power button may be pushed to switch on the digital board. A welcome screen of any suitable type may then appear preferably in the center of the two screens that now operate together to provide text and other material in newspaper or book form or such other form that may be presented.

On the bottom of screen B (right screen), there will also appear, from left to right, three possible boxes. The first box contains the words “Board empty”, the second box contains the words “Saved data”, and the third box contains the words “Ready data” (see FIG. 2 of the drawings). Typically, only one or two of these selections will be shown at one time. Either “Board Empty” with “Ready Data”, or “Saved Data” with “Ready data” will be shown. One uses buttons 52 and 54 (described further below) having left and right arrows respectively, together with a button in the center of the two arrows. The arrow buttons are used to move from “Empty” to “Saved” or “Ready” data. Ready data comprises content that may have just arrived and is ready for accepting or rejecting. Saved data is simply that which has already been reviewed or accepted. If the Board is Empty, or there is Saved or Ready data, then that particular box will be lit or highlighted in some way. The left and right arrows may be used to move to the box selected.

If the user selects “Ready” data (i.e. something new is now available downloaded) when that box is lit, then the user pushes the button next to the Ready light 56 which is button 58 and the titles received will be displayed on the screen (on screen A or the left screen and will continue on to screen B or the right screen if needed). Before one can select ready data, it may be necessary to call an 800 or other number or the publisher to place an order. When the subscriber calls to purchase a paper or any product offered, he will, in accordance with one aspect of the invention, place the order with an operator or automated teller, be instructed to open the digital board and press data button 58 and while on the phone the title is sent to the board. It could appear within seconds, and the user will accept or reject it while the operator is on the line to assure there are no mistakes in the title ordered. Once a title is accepted, the user is automatically billed or it will be deducted from the board account which has been set up. This will assure no downloading of data that is not wanted.

Procedure to accept or reject: The first title on the list will be lit or highlighted, and next to this title there will be two boxes adjacent each other. This is shown in FIG. 2 of the drawings. In the first box is the word ACCEPT and in the second box is the word REJECT. The first box next to the title will be lit (ACCEPT) if this is a title which has been ordered. If this title is desired, with the box lit the blue button 60 (or illustrated for Saved data) is pushed and that title (which may come out of the user's board account, for example) is fully downloaded for the reader's use.

If it is a title that the user did not order, the left and right arrows 52 and 54 are used to move the highlight to the right or lower box (Reject) and then button 62 (or Delete data icon 64) may be pushed so that particular title will be accepted or rejected and deleted and the user will not pay for that title. Using button cluster 66 (including up and down arrows), the user can select the next title below the first one and repeat the process to ACCEPT or REJECT such title. This may all occur while talking to an 800 operator, automated or online. When the user is done ordering he may turn the digital board off and then press the actual light that sits on the side of the board below button 56 the ready data button. The light on the side of the button No. 6 is also the button to push for standby mode to be on while the digital board is off. The standby light button when pushed allows the board to receive the titles ordered previously. One may sleep at night and charge the digital battery while the board is on the standby mode ready to receive the titles ordered, so that when the user wakes up the titles are downloaded onto the board and when the board is ready to be turned on, the ready data button 56 is pressed. The titles are displayed on the screens since the user has already accepted titles, which are ready for the user to process by pressing the saved button 60.

Using buttons 66, the user can select the next title below the first one and repeat the process to ACCEPT or REJECT such title. When the user has gone through the full list of titles shown on the screen A, he or she is now ready to read any of the titles that were selected and have been received and stored in the digital press device.

Other buttons and constructions with respect to FIG. 2 of the drawings can be summarized as follows:

(1) Power ON/OFF button 50.

(2) PLAY/PAUSE and turn pages left or right 52 and 54.

(3) MAGNIFIES/COLOR 66: The two arrows may scroll the pages of the newspapers or maps up and down and may also scroll the magnified sentence up and down the pages being read, when pushed. The color button may change basic black print to soft blue, green or yellow, when pushed.

(4) PHOTO BUTTON 70: This button 70 may “activate” photos in newspapers, books and other material to video form. Telly Treks, PT's private Treks information or study Treks may be activated by Play/Pause buttons 52 and 54.

(5) SAVE/RECALL button 60: The storage and/or subsequent retrieval of can be effected with this button. Further, certain material can be printed or P.C. to use, print or view at a later time.

(6) A green light 56 blinks when orders or material has arrived at the device, and these materials can be accepted or rejected.

(7) The button 62 may be used to accept or reject any material sent and received on the device. The scroll up and down buttons 66 may be used to highlight the received material, and the left/right arrows buttons 52 and 56 used to place the light on accept or reject as appropriate (see for example Screen A in FIG. 2 where three titles are shown each having an accept or reject icon for use in this regard).

(8) USB outlet 74 is provided for communication with a computer of other device as desired.

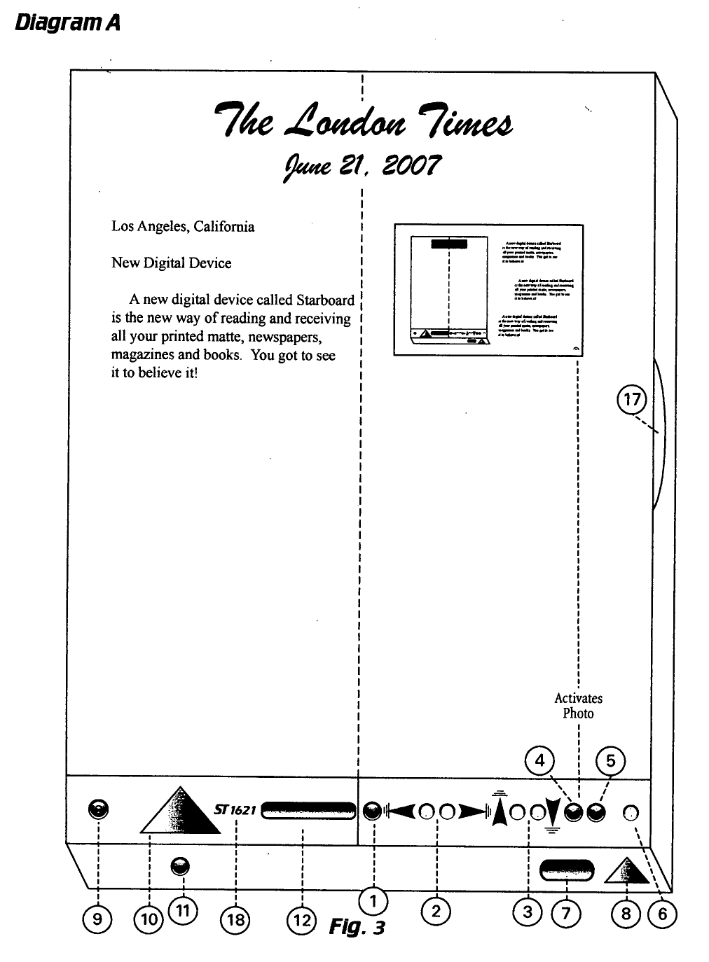

(9) The button 76 may turn on any lights that are on the outside of the digital device. In one form, pushing the button three times may change the rhythm of the lights on the outside or the rim of the digital device. Pushing once or twice may create different rhythms and a third push allows the lights to take up the rhythm of MMT's & T.T. audio material sound effects from Books or Treks (see for example FIG. 3 of the drawings).

(10) SPEAKER 78 may be provided for sound, audio books and other material with sound.

(11) EARPHONE connector 80 may be provided for private listening.

(12) SCREEN UNLOCKING LATCH 82. This button 12 may be pushed to the left and unlocks the two tablets or screens on the digital device.

(13) ANTENNA 84. The antenna 84 receives wireless data for the digital device.

(14) BATTERY COMPARTMENT 86. This may be located at the top of screen B (the right side) of the digital device, or any other convenient place.

(15) MULTI MEDIA CARD MEMORY CHIP COMPARTMENT 88 (see FIG. 3) may be located next to the battery compartment 86.

(16) POWER connection 90. An power connection may be made through this connection to run the digital device directly from AC power and/or to charge the battery.

(17) SAFETY LOCK 92. This lock allows opening and closing of the digital device. Preferably, when unit is closed, the lock is located at the center of the left side of the digital unit.

### Accessories and Other Parts

A digital board stand may be provided allowing the user to locate the digital board in a raised, angled or elevated position, to assist in operation. The device can be connected to the power source while in the stand.

An earphone may come with the digital board (left and right) for private listening to audio and visual books, newspaper activated photo's or want ads, and MMT's or PT's for short (namely, private multimedia treks). Customized earphones may also be provided and feature M-DAS (Multi-Dimensional Aerial Sound). MDAS gives the illusion of full dimensional sound. This sound process can be added as effects to recorded material or used in actual recordings of MMT's to give the illusion that one is there in person.

MMT's or PT's may be utilized by the digital device as a new sound and lyric art delivery form. MMT's as mentioned stands for “Private Multi-Media Treks” or “PT's” (private treks) and a PTB is a Private Trek Book which may consist of a selected number of treks, depending on the choice of the buyer. MMT's is a new and unique form of delivering music art for the professional or public at large. A song or a music piece is a single trek. Each trek has a beginning, a middle and an end. If the TREK (or song or music piece) already has an existing video, then it will display the music score and or lyrics. The digital device may become a split screen for MMT's, books or certain downloads in order to provide the display as needed.

In addition to MMT, there is Telly Treks (past or current television episodes for sale), Info Treks (comprising for example past or current information treks, travel, documentaries, how to and geographic lessons, music lessons and the like). Instructional lessons from a school or universities are known as STUDY TREKS. With this system and device in place all classes may be filmed and students who miss certain classes can obtain them hours later as Study Treks. Thus, a student can not only obtain information or lessons given during the particular class but also experience the actual feel and response from the teacher or students.

The “galactic” digital pages comprise a digital version of all the newspapers and magazines available in towns, cities, states and countries of the world. It would be possible to look up a city in a particular country and get the list of newspapers, magazines, books, plays, P.T.'s, Telly Treks, Info Treks available in that town, city, state, country.

There is generally no need for a “mode” button. The digital device is preferably programed to automatically change to whatever mode is required when choosing what to read. Stored books, newspapers, magazines or MMT's or PT's, TT's, IT's, are displayed when pressing the saved button.

In an upgraded embodiment of the digital device of the invention, a cell phone may be provided. Aside of making calls to place subscription orders for the digital device, and then receiving or rejecting orders, the digital device may receive the printed matter for a customized library. Also a feature may be provided where you may call other digital devices and see each other while talking. A conference call of 2 or 3 or 4 persons may display on the screens split images of the people conversing.

### Procedure for Operating the Invention

When the digital board is opened, two screens will be seen. These are inside when the digital board is closed so as to be protected from damage when the digital board is not in use. The right side is designated as screen B which is preferably stationary and the left side is screen A. When opening the digital board, there will be about a k inch gap between screen A and screen B. Gently slide screen A to the center and touch screen B. A small click will sound that indicates the screens A and B are now locked together and ready for use. At this point, the power may be switched on by pushing button No. 1 located on the frame of the digital board below the bottom of screen B. From left to right along this frame there are seven buttons, the first of which is the power button, as described.

In order to proceed to read content already captured or to be captured on the digital board once the power is on, the digital board lights up as one screen. A logo may appear on the center of the screen. The left and right arrows (referenced as numeral 2) are used and button No. 5 (“Save Data”) is pushed. The titles will appear on the screen in a manner described above. Using button No. 3, with the up and down arrows, the title is selected. The light or highlighting travels up and down the list of titles on the screen as the user presses on the up or down arrows. When the user stops on the title desired, the Button No. 5 is pushed again (Save Data) and the cover page of the title-chosen appears. If it is a book or magazine, and if it is a newspaper, then the first page thereof appears. In the center of button No. 3 is a middle button. When the user pushes that button the first time, the first sentence of the book or article on the first page is magnified in the same black color. Pushing the button a second time changes the color of the text to a soft blue. If pushed a third time, the color changes to a green. If pushed one more time (the fourth time), then the magnification turns off. This option may be preferred by readers who prefer a soft color and/or magnification for easy reading.

With the first sentence magnified, the user then operates the same button No. 3 with the up and down arrows. The down arrow moves the magnification from the first sentence to the next sentence, and then the next, and releasing the arrow stops this sequential magnification of sentences. As the user presses the “down” arrow, the article scrolls upward, and if the “up” arrow is pressed, the article scrolls downward, and the magnified sentences begin moving upward. If the reader is not using the magnification or color feature in the center of the two arrows (button No. 3), then the use of the two up and down arrows scrolls up or down through the page which is being read. When the reader has completed a particular page, button No. 2, with arrows to the left and right, are pressed to turn the pages forwards or backwards so that subsequent page can be displayed on the screens. When the reader has completed the reading, or in fact at any time, button No. 5 may be pressed once (Save Data) and the book, magazine or paper displayed will go off the screen and the list of titles appears again.

The power button No. 1 is pressed to turn the digital board off. When the power is off, the release switch (reference numeral 11) for screen A on the bottom center-left is used to slide back to the left edge of the digital press device, and the digital press device can be closed like a book. On the outer center portion of the digital press device, there is located a lock that slides into place when the digital press device is closed, thereby locking the device.

### Operations

Power on/off: In order to open the digital press device, the user must pull out a latch preferably located on the outer center frame portion of the device, which then opens in a book-like fashion. Thereafter, screen A is slid on to screen B, touching screen B on the right side edge thereof. A clicking sound indicates that the two screens A and B are locked together and the power can now be turned on.

Arrows left/right: When the digital board is turned on, the first thing that appears may preferably be a welcome logo which may be in the center of the screens of the device. On the bottom right of screen B, there may be three selections displayed in three boxes from left to right in a row: BOARD EMPTY, SAVED DATA or READY DATA (see FIG. 2 of the drawings). Use of the left and right arrows highlight the selection desired and the appropriate corresponding button is pressed whereupon the titles loaded or ready for download will appear. The left and right arrows are used to turn through pages when reading a title. The user may turn the through the pages back and forth and also move between highlighting the ACCEPT and REJECT options displayed for each title when they first appear as an option for potential downloading.

Up and down arrows: The device has up and down arrows with a button in the center, between the two arrows.

The up and down arrows first move the light or highlighting of material on the screen up and down the list of titles displayed thereon. When the user chooses a title to read, the button (Saved Data) is pressed and the cover or first page of the title is displayed to read. Then the up and down arrows may be used to scroll up or down through the document or article being read as and when needed. While most books and magazines are preferably displayed in their full form as would be seen for the printed version, newspapers and other special books or atlases are, however, in longer form. The arrows will scroll up or down the article or column the user is reading to facilitate reading of all types of formats and displays.

The center button between the two up and down arrows is a reading assistance feature. Pressing it once has the effect of magnifying the first sentence on the page which the user is reading. Pressing the button a second and/or third time will alter the text color of the sentences and script highlighted, from black to soft blue or sea green respectively. Pressing this button a fourth time will cause the color and magnification to be turned off, returning the script color and size to normal or default status. When using the magnification feature, the up and down arrows will move the magnification sequentially from the first sentence to the second and third sentences and so on, as desired by the user, all in chronological order, as quickly as the arrow button is pressed. If the DOWN arrow is pressed and held down, the sentence which is being magnified will move from one to the next and scroll down the page. The UP arrow may be used to go back up the column or text in reverse fashion.

Photo Activator: The preferably red button with the word PHOTO printed on it “activates” any of the photos on that page in chronologic order from top to bottom. Once activated, a short or mini video is run. Some photos are simply still photos and some may also be a link or connection to short video displays. These videos may of course be of any suitable duration, and may typically run for from 1 to 5 minutes. When the user presses the photo button, the still video is “activated” or transformed to run 1 for 5 minutes (or other suitable time duration) and then stop. As the user continues to read the columns and text, photos may be incorporated. In one embodiment, a photo with a small red dot on the upper left corner (or other suitable location) of the photo, can be “activated” into a short video by pressing the photo button 4. The user can also stop any photo video during the course of its display by pressing the red button. If pressed again, the next photo on that page or column activates, and pressing it once again causes it to stop.

Saved Data: (preferably a blue button) The first time this button is used is when the reader makes a first title purchase. When following the procedure to ACCEPT or REJECT a title, a title is accepted after moving the light or highlight to the box that says ACCEPT, then pressing the Saved Data button, whereupon that title is then saved in the memory of the digital board.

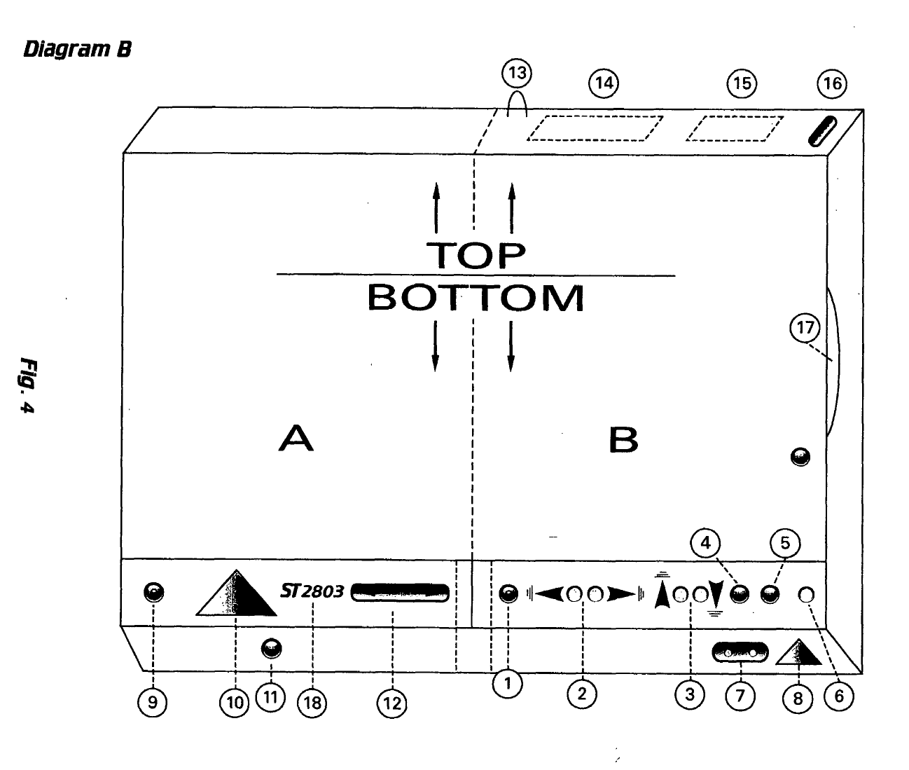

Button 2 in FIG. 4, or such other button(s), may be used for play and pause operations when viewing video data. The appropriate button can activate the photo, as discussed, and further use of the button may advance to the next photo, if it is present, so the user can work through the photos.

Also, the Saved Data may be used when the reader opens the digital board and wants to recall any previously stored titles to read. In such a case, the reader turns the digital board on and presses the Saved Data button and a list of previously saved titles will be displayed on the digital board. The up an down arrows are then moved to highlight the desired title for selection, and the Saved Data button is pressed once more. At this point, the first page of the desired title appears ready for reading and scrolling as described above. If the user presses the Saved Data again while reading a page, then that page disappears and the list of titles is displayed once again, ready for the user to choose another.

A further use of the button is effected when the user desires to download any of the titles on the digital board on to a computer or other device to save a hard copy on the PC. To achieve this, the user must plug in a USB cable at outlet shown in FIG. 2 of the drawings, turn on the digital board, plug in the USB cable to the desired DVD player or personal computer, and then press Saved Data button. At this juncture, the title list appears preferably at the top and on the bottom of screen B. Three selections will also appear from left to right in a row. The first selection is DOWNLOAD/COPY, activation of which will commence the download of the selected titles into a PC or DVD player and free up space on the digital board. The second selection is DOWNLOAD/BOARD. This selection may be used when the reader wants to download data or text from hard copies saved to a computer or the like back to the digital board, i.e. for books previously read or saved or past periodicals that the user has saved and wants to read again. The third selection is DELETE/TITLE which allows the user, by using the up and down arrows, to move the light or highlight to the titles either copied or read and no longer wanted. The user then presses button (to Delete) and that title will be deleted and removed from the digital board. There may be a media card in your digital board that allows the user to store or recall titles for the digital board. Safeguards may be incorporated into the system to prevent accidental deletion of material, for example by asking the user if he/she really wants to delete the selected material for deletion.

READY/DATA, button: The Ready data button and the light that is located on the side of the board (see FIG. 2 of the drawings) is also a utilizable button. This button may be pushed to receive titles onto the digital board when the user orders a title. The light may also be pushed in when the user wants to place the digital board on standby (low battery use) to receive titles (downloaded) into the digital board while, for example, the board is not in use or the user is asleep. As such, the user does not have to wait around to receive the ordered titles.

DELETE/DATA, Button: This button may be used in at least two ways. The first use when the reader is reviewing ordered titles and one or more amongst such titles is not one that is wanted. Use of the DELETE button will delete that title and the user will of course not have to pay for it. A second way to use this button is when the user has the USB connector on. In this situation, the user may use the DELETE button to delete any title from the digital board.

USB outlet: This is the outlet into which the USB cable is plugged for downloading and/or recalling data for the digital press device.

Illumination button: This button is for illuminating the outside of the digital board as well as the controls. Further, a thin line that outlines the digital board may be illuminated. This button provides the illumination of essential buttons and portions of the digital board which facilitates the user in turning it on for operating the digital board in the dark, on a bus, a room at night and the like.

Speaker: A grille is formed on the frame of the digital press device to cover a speaker located thereunder for providing the sound which may be needed for the activated videos. Furthermore, adjacent the grille or anywhere on the digital board, there is located a plug for earphones, to enable private listening.

Unlock button: This unlock button in FIG. 2 of the drawings may be pressed and moved to unlock the two screens A and B when the user has completed reading and wants to close and shut down the digital board.

Antenna: This antenna extends slightly from the top of screen B. However, it will be appreciated that the antenna may be in any suitable location and have any suitable structure.

Battery/Media Card: A battery and/or media card location and compartments may be formed in the digital press device. Preferably, the media card is placed next to the battery. Both are removable. An AC wall charger for the battery will come with the digital board for recharging the battery.

AC plug connector: An AC connector plug is provided to connect the unit to an AC outlet for in home reading while charging or preserving your battery time.

Lock/Latch: The lock/latch is a mechanism which simply locks the digital board when in closed position, in order to securely hold the two screens A and B in the closed position.

It should be noted that when a device is purchased by a user, the first title may be offered free from the manufacturer, and in any event, printed and video material containing instructions for operating the device will be sent.

In summary, the invention provides a digital press device or digital board which is adapted to receive and display books, newspapers, magazines and other material. The device has no keyboard, but comprises a series of buttons or activation mechanisms to download selected material. The device is set up to automatically receive subscription issues of newspapers and magazines with the option to accept or reject such issues. Preferably, the device has a pair of screens or monitors which open and close in book like fashion to present a reading format which may emulate a conventional book or newspaper.

Preferably, the device has wireless receiving capacity so that it will receive the preselected issue of a newspaper or magazine or a book wherever it is located and within the range of appropriate wireless transmissions. Various tools are provided to enhance text by magnification or color techniques. The device may store a limited number of issues, which may be cleared as desired to make room for new issues and editions. Further, the device may comprise on screen prompts which are user friendly and simple to operate in order to alert the user of material on the device or material ready for processing. Scrolling arrows and buttons are provided to activate prompts and achieve desired download of material.

The device is intended as an effective replacement of printed material which can preferably be displayed in electronic format in a manner easy to read. One advantage is the ability to receive, for example, newspaper deliveries in electronic format on a daily basis wherever the user is located and thereby avoid large quantities of material from being printed on paper. The environmental benefits are significant.

The device may include the ability to deliver sound and sound effects as well as the ability to show video streams when available.

The invention is not limited to the precise details described herein and many variations and modifications are possible within the scope of the invention.

1. A digital reading device comprising:
a pair of tablet portions each having a display screen, the tablets being foldable relative to each other between a closed position wherein the display screens are protected and not visible and an open position wherein the screens are adjacent and coplanar with respect to each other so as the present a book-like viewing area;
receiving means for receiving text and graphics separable into units or pages from a remote source and displaying the text and graphics on the display screens;
memory for storing the text and graphics received from the remote source;
a set of simple navigation keys for storing the text and graphics in the memory and reading the text and graphics.

2. A digital reading device as claimed in claim 1 wherein the receiving means is configured to receive text and graphics from WiFi, satellite and/or broadband signals.

3. A digital reading device as claimed in claim 1 wherein the text and graphics comprise one or more of newspaper editions, books, magazines and journals.

4. A digital reading device as claimed in claim 1 wherein the navigation keys comprise an up/down key cluster for moving the text and graphics on the screen up and down on the screen and a left/right key cluster for sequentially reviewing or advancing to previous or next pages in the text or graphics respectively.

5. A digital reading device as claimed in claim 1 wherein the navigation keys comprise a photo key for activating one or more photos in the text or graphics to display a video stream associated with the photo.

6. A digital reading device as claimed in claim 1 wherein the navigation keys comprise a save key for saving text or graphics received from the remote source to the memory.

7. A digital reading device as claimed in claim 1 wherein the navigation keys comprise a ready light and key cluster signaling the presence of received text and graphics.

8. A digital reading device as claimed in claim 7 wherein the navigation keys comprise an accept/reject key cluster for accepting or rejecting text and graphics which have been received by the receiving means.

9. A digital reading device as claimed in claim 1 further comprising a transmitter for transmitting a signal to a remote source to check for availability text or graphics to be transmitted to the receiving means.

10. A digital reading device as claimed in claim 1 wherein the receiving means is automatically set to receive text and graphics from the remote source on a programmed periodic basis.

11. A digital reading device as claimed in claim 1 wherein each tablet comprises a substantially rectangular box frame structure having opposing flat sides and a long edge and a short edge, the display screen being formed on one of the opposing sides.

12. A digital reading device as claimed in claim 11 wherein one of the long edges on each of the tablets comprises a locking member whereby the locking member on each of the tablets can be releasably locked to each other to configure the tablets between the closed position and the open position.

13. A digital reading device as claimed in claim 12 further comprising electrical contacts on one of the long edges of each the tablets which engage one another when the tablets are in the open position in order to establish electrical contact between the two tablets.

14. A digital reading device as claimed in claim 1 further comprising at least one navigation icon which can be displayed on at least one of the display screens for operating the digital reading device.

15. A digital reading device as claimed in claim 14 wherein the navigation icon is activated by touching.

16. A digital reading device as claimed in claim 14 wherein the navigation icon is activated by one or more of the navigation keys.

17. A digital reading device as claimed in claim 14 wherein the at least one navigation icon comprises an icon for accepting text and graphics received and an icon for rejecting text and graphics received.

18. A digital reading device as claimed in claim 1 wherein the receiving means is further able to receive sound and audio and the digital reading device further comprises a speaker for playing the sound and audio at the appropriate prompting by the user.

19. A digital reading device as claimed in claim 1 further comprising an electrical connector for connecting the device to a computer.

20. A digital reading device as claimed in claim 1 further comprising an antenna for facilitating receiving of text and graphics from the remote source.

21. A digital reading device as claimed in claim 1 further comprising a rechargeable battery for powering the device.

22. A digital reading device as claimed in claim 1 further comprising a multimedia card slot for accepting multimedia cards or other data from a card inserted therein.

23. A digital reading device as claimed in claim 1 further a security code for ensuring security between the device and the remote source.

24. A digital reading device as claimed in claim 1 further comprising means for programming subscription data for selectively controlling receipt on an ongoing basis of text and graphics from designated remote sources.

25. A digital reading device as claimed in claim 1 further comprising means for controlling the color, background or magnification if text for enhanced viewing.

26. A digital reading device comprising:
a display screen presenting a book-like viewing area;
receiving means for receiving text and graphics separable into units or pages from a remote source and displaying the text and graphics on the display screen;
memory for storing the text and graphics received from the remote source;
a set of simple navigation keys for storing the text and graphics in the memory and reading the text and graphics; and
means for programming subscription data for selectively controlling receipt on an ongoing basis of text and graphics from designated remote sources.

27. A method of reading text and graphics on a digital display device, the method comprising:
forming a pair of tablet portions each having a display screen, the tablets being foldable relative to each other between a closed position wherein the display screens are protected and not visible and an open position wherein the screens are adjacent and coplanar with respect to each other so as the present a book-like viewing area;
receiving text and graphics separable into units or pages from a remote source and displaying the text and graphics on the display screens;
providing memory for storing the text and graphics received from the remote source and accepted by the user; and
storing the text and graphics in the memory and reading the text and graphics by means of a set of simple navigation keys.

28. A digital reading device comprising:
a display screen foldable between a closed position wherein the display screen are protected and not visible and an open position wherein the display screen presents a book-like viewing area;
receiving means for receiving downloadable material separable by the device into units or pages from a remote source and displaying the material on the display screen;
memory for storing the material received from the remote source;
navigation keys for optionally storing the material in the memory and reading the material.

29. A system for transmitting reading material to a digital reading device comprising:
providing a digital reading device having a display screen which presents a book-like viewing area;
locating a receiving means in the digital reading device for receiving text and graphics separable into units or pages from a remote source and displaying the text and graphics on the display screens, the receiving means being connected to a dedicated communication line separate from the Internet;
providing memory for storing the text and graphics received from the remote source;
communicating with a text and graphics source provider for securing a subscription or material from the source provider to be transmitted to the digital reading device through the dedicated communication line; and
forming a set of simple navigation keys on the digital reading device for storing the text and graphics in the memory and reading the text and graphics.
